(19) United States
(12) Patent Application Publication
(10) Pub. No.: US 2005/0288107 A1
(43) Pub. Date: Dec. 29, 2005

(54) Yoke-trunnion universal joint without needle bearings

(75) Inventors: Jianqun Zhou, Hangzhou City (CN); Guohui Sun, Hangzhou City (CN); Jianzhi Ma, Hangzhou City (CN); Hongzheng Shao, Hangzhou City (CN); Jun Wu, Hangzhou City (CN)

Correspondence Address: RADER FISHMAN & GRAUER PLLC, LION BUILDING, 1233 20TH STREET N.W., SUITE 501, WASHINGTON, DC, 20036, US

(73) Assignee: WanXiang QianChao Co., Ltd.

(21) Appl. No.: 11/024,621

(22) Filed: Dec. 30, 2004

(30) Foreign Application Priority Data
Jun. 23, 2004 (CN) 200420023868.5

(51) Int. Cl. F16D 3/16

(52) U.S. Cl. 464/132

(57) ABSTRACT

A yoke-trunnion universal joint includes a universal joint body, a cup and an anti-wear coating. The universal joint body has a trunnion nose. The cup has an inner wall surface defining an internal cavity sized to slidably receive the trunnion nose. The anti-wear coating is disposed between and in contact with the trunnion nose and the inner wall surface of the cup when the trunnion nose is received by the internal cavity of the cup.

### TECHNICAL FIELD

This invention relates to an improved structure of yoke-trunnion universal joint and, particularly, to a compact trunnion universal joint without needle bearings.

### BACKGROUND OF THE INVENTION

A conventional yoke-trunnion universal joint has a complicated structure between its trunnion ends and cup, leaving a large clearance therebetween. This, in turn, leads to loose construction and reduced strength. Moreover, needle bearings are rather complicated to manufacture, process and assemble and they easily wear out and run with a loud noise. For example, one kind of universal joint has been applied for patent (Chinese application No.: 87013541) that needs filling with lubricating oil to assure uniform and long-term lubrication at all four roller bearings. To meet these needs, two springs are installed in two vertical passages of the yoke trunnion. Before installation, the length of the springs is greater than the axial size of the passage. After installation, both ends of each spring contact the inner end surface of the corresponding bearing housing. Such universal joint is quite complicated and the springs lead to a loose structure and high assembly difficulty, tend to wear out, runs with loud noise and are hard to seal tightly. Oil leakage often occurs so that the universal joint has a shortened service life and is not economical.

### OBJECTS AND SUMMARY OF THE INVENTION

This invention aims at solving the above-mentioned problems of a complicated needle-bearing structure of a yoke-trunnion universal joint between a trunnion nose and a cup, a loose structure and a large trunnion nose diameter or a cup diameter caused by the clearance no less than the needle diameter, and reduced strength of whole universal joint.

This invention also avoids the technical problems of prior art such as complicated manufacturing, processing and assembling of the needle bearing, easily wearing out and improper sealing.

This invention also avoids oil leakage in a conventional universal joint so as to prevent the trunnion from early retirement from service. It provides a yoke-trunnion universal joint of easy manufacturing, processing and assembly with smooth running and low noise, particularly at high speed and light load.

This invention solves the above-mentioned problems through the following technical scheme: a yoke-trunnion universal joint without needle bearing incorporates a yoke trunnion and a cup set in a trunnion nose with an oil seal at its end, is characterized by a cylindrical or cup-type soft anti-wear coating between the cup and the trunnion nose.

For an exemplary embodiment, the soft anti-wear coating is homogeneous and roughly isopachous. It is fabricated from a nylon material coating the circumference and endface of the trunnion nose and the soft anti-wearcoating clinging to a chamfer is designed between the circumference and bottom, wherein the nylon material is special nylon.

For an exemplary embodiment, the soft anti-wear coating is homogeneous and roughly isopachous. It is fabricated from a special nylon material coating the inner wall and bottom of the trunnion cup. In another exemplary embodiment, annular overrun grooves are designed aslant between the inner wall and bottom of trunnion cup, the soft anti-wear coating is uniformly coated over inner wall, bottom and the overrun groove.

For an exemplary embodiment, the average thickness of the soft anti-wear coating is 0.10-0.60 mm. Generally, the thickness depends on the coating material strength and other performance characteristics, and also on the size of universal joint, load and rotational speed.

For an exemplary embodiment, an annular groove is designed near the base of trunnion and the inner face of soft anti-wear coating is filled in the groove. Thus, though the external surface of soft anti-wear coating keeps on cylindrical shape, the rim of inner opening is yet strong enough to make the layer more reliable and endurable.

For an exemplary embodiment, coating surface roughness of the trunnion or cup Ra is 0.8-3.6 μm, fully utilizing the adhesive force and springiness of the soft anti-wear coating to directly coat the trunnion nose processed by a lathe.

For an exemplary embodiment, annular, helical or meshy webs are designed on the external surface of the soft anti-wear coating to improve the performance of product.

For an exemplary embodiment of an alternative scheme, annular, helical or meshy grooves are designed on the external surface of the soft anti-wear coating to improve the performance of product.

Therefore, this invention has the following features: 1. simple structure and easy to manufacture, greatly avoiding the multiple processes or inconvenience brought by manufacturing and assembling needle bearings; 2. a more compact structure, reducing the space (clearance) of distributing needle bearings in a traditional trunnion universal joint to several or more millimeters and creating conditions of reducing a diameter of the trunnion nose or cup; 3. avoiding direct contact and abrasion between the needle bearing and the metal surfaces, significantly reducing running noise and making operations smoother; 4. eliminating oil or grease filling and thus eliminating the problem of oil leakage; 5. reducing the hardness requirement for the trunnion nose or cup inner wall and becoming an improved lubricating-free and maintenance-free trunnion universal joint. The technical scheme of this invention is especially suitable for a high-rate and light-load yoke-trunnion universal joint.

### BRIEF DESCRIPTION OF THE DRAWINGS

FIG. 1 is an elevational view partially in cross-section illustrating the structure of the first exemplary embodiment of a yoke-trunnion universal joint of the present invention.

FIG. 2 is an enlarged elevational view partially in cross-section of FIG. 1 illustrating the structure of a trunnion nose.

FIG. 3 is an elevational view illustrating the structure of this invention.

FIG. 4 is the cross-sectional view taken along line B-B in FIG. 3.

FIG. 5 is an enlarged cross-sectional view of cup of the invention.

FIG. 6 is an enlarged view of the trunnion nose.

FIG. 7 is a different enlarged view of the trunnion nose.

### DETAILED DESCRIPTON OF THE EXEMPLARY EMBODIMENTS OF THE INVENTION

By referring to the drawings, the technical scheme is further described through the exemplary embodiments.

### Embodiment 1

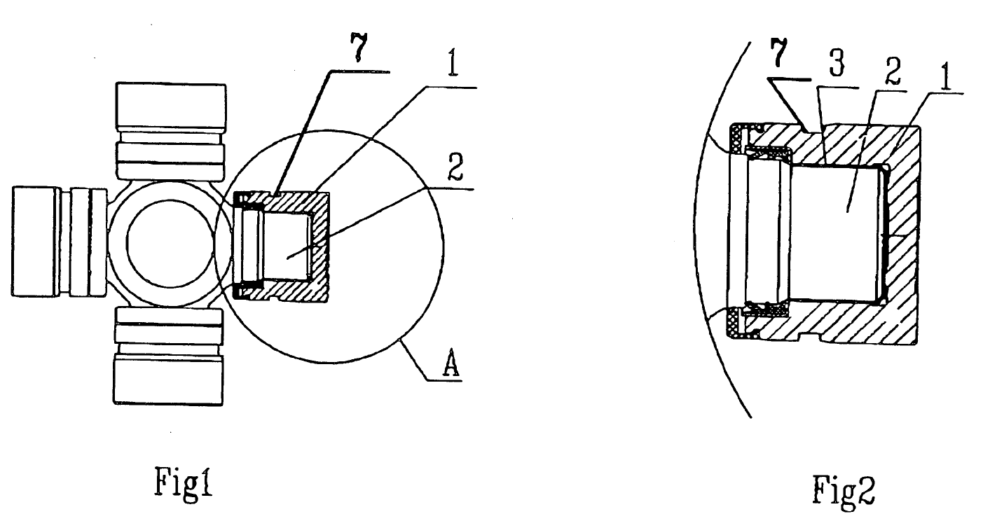

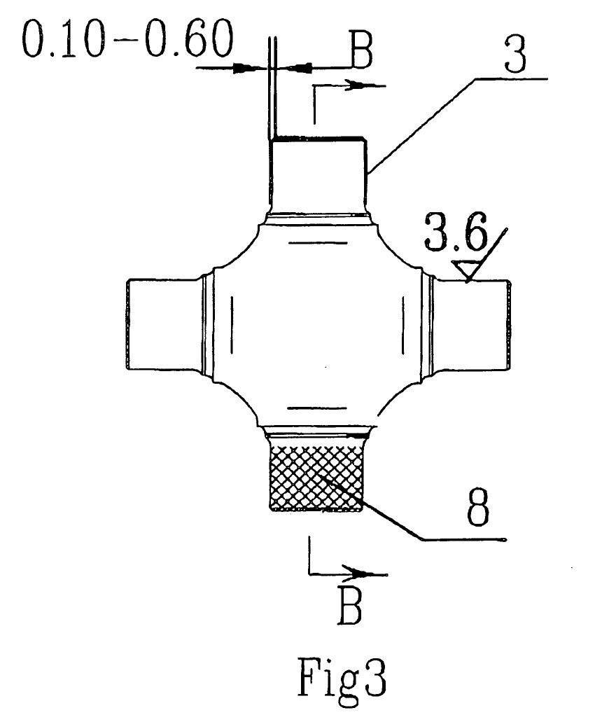

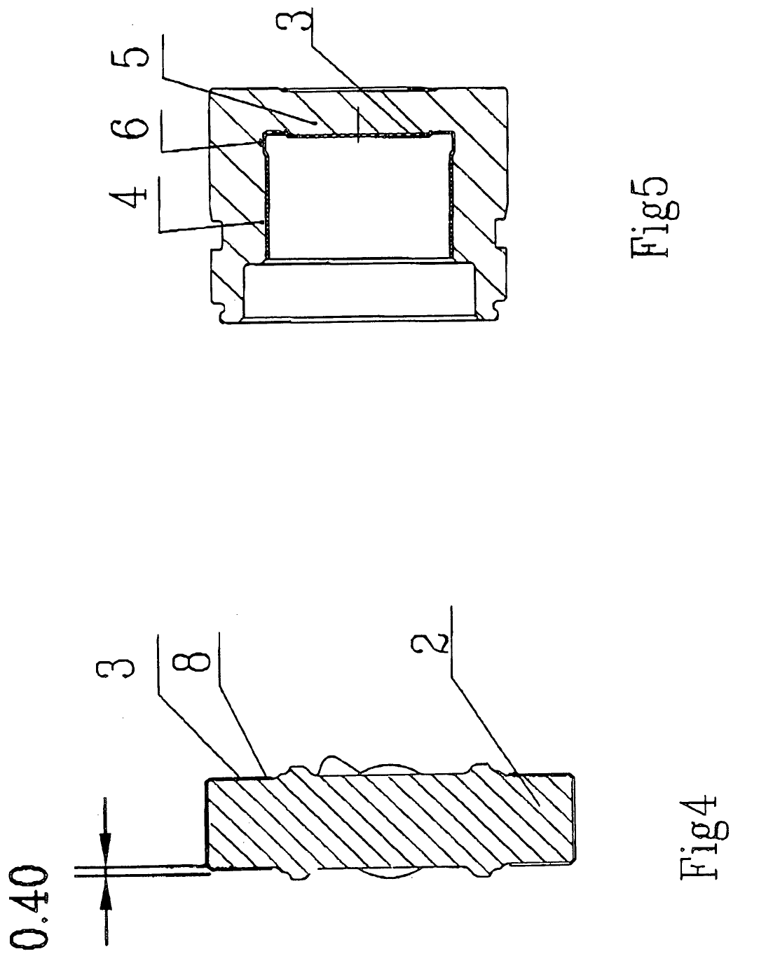

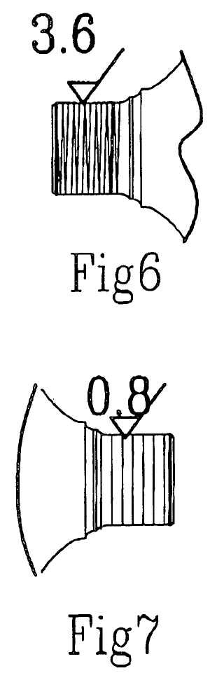

A yoke-trunnion universal joint without needle bearings as shown in FIG. 1 incorporates a yoke trunnion and a cup 1 that is set at a trunnion nose 2. The end of the cup 1 has an oil seal, between cup 1 and 2 is homogeneous and roughly isopachous soft anti-wear coating 3 of cup shape. Soft anti-wear coating 3 is constituted by nylon material coating the cirumferential and end surface of trunnion nose and connecting to the chamfers between the cirumferential and end surface. The average thickness of soft anti-wear coating is 0.40 mm. Annular webs are designed on the surface of soft anti-wear coating 3. The surface roughness Ra of coating on trunnion nose 2 and cup 1 is 1.6 μm.

In the case that an annular overrun groove 6 is set aslant between the inner wall 4 and bottom 5 of the cup, soft anti-wear coating is uniformly coated on inner wall 4, bottom 5 as well as overrun groove 6. An annular overrun groove 7 is set near the base of trunnion nose and is filled up with soft anti-wear coating 3.

### Embodiment 2

In this embodiment, helical grooves are designed on the external surface of soft anti-wear coating 3; the other properties are the same as embodiment 1 and no more description is needed.

The present invention, may, however, be embodied in various different forms and should not be construed as limited to the exemplary embodiments set forth herein. Rather, these exemplary embodiments are provided so that this disclosure will be thorough and complete and will fully convey the scope of the present invention to those skilled in the art. Additionally, one of ordinary skill in the art would appreciate other advantages and benefits of the present invention that are not specifically discussed.

1. A yoke-trunnion universal joint, comprising:
a universal joint body including a trunnion nose;
a cup having an inner wall surface defining an internal cavity sized to slidably receive the trunnion nose; and
an anti-wear coating disposed between and in contact with the trunnion nose and the inner wall surface of the cup when the trunnion nose is received by the internal cavity of the cup,
wherein the trunnion nose has an outer circumferential surface and an endface, said outer circumferential surface and an endface being metal,
wherein the inner wall surface of the cup (i) comprises a metal surface and (ii) includes a cylindrical inner wall and a bottom wall forming a generally cylindrical cavity, and
wherein the anti-wear coating is disposed on (i) the inner wall and the bottom wall of the cup, or (ii) the outer circumferential surface and the endface of the trunnion nose, or (iii) both the inner wall and the bottom wall of the cup and the outer circumferential surface and the endface of the trunnion nose.

2. (canceled)

3. The yoke-trunnion universal joint according to claim 1, wherein the anti-wear coating is homgeneous.

4. The yoke-trunnion universal joint according to claim 3, wherein the anti-wear coating is substantially isopachous.

5. The yoke-trunnion universal joint according to claim 4, wherein the anti-wear coating has an average thickness in a range of approximately 0.10 mm and 0.60 mm.

6. The yoke-trunnion universal joint according to claim 1, wherein the anti-wear coating comprises a nylon material.

7. (canceled)

8. The yoke-trunnion universal joint according to claim 1, wherein an annular overrun groove is formed in the internal cavity of the cup extending into the inner wall and the bottom wall.

9. The yoke-trunnion universal joint according to claim 8, wherein the anti-wear coating comprises a nylon material.

10-11. (canceled)

12. The yoke-trunnion universal joint according to claim 1, wherein coating surface roughness Ra of the trunnion nose or the cup is 0.8-3.6 μm.

13. The yoke-trunnion universal joint according to claim 6, wherein coating surface roughness Ra of the trunnion nose or the cup is 0.8-3.6 m.

14-15. (canceled)

16. The yoke-trunnion universal joint according to claim 1, wherein annular, helical or meshy webs or grooves are formed into an external surface of the anti-wear coating.

17. The yoke-trunnion universal joint according to claim 6, wherein annular, helical or meshy webs or grooves are formed into an external surface of the anti-wear coating.

18-19. (canceled)

20. The yoke-trunnion universal joint according to claim 1, which has no needle bearing.
